(19) United States
(12) Patent Application Publication
(10) Pub. No.: US 2010/0075101 A1
(43) Pub. Date: Mar. 25, 2010

(54) Cast-on-Tricot Asymmetric and Composite Separation Membranes

(76) Inventor: Man-Wing Tang, Cerritos, CA (US)

Correspondence Address: HONEYWELL/UOP;PATENT SERVICES, 101 COLUMBIA DRIVE, P O BOX 2245 MAIL STOP AB/2B, MORRISTOWN, NJ, 07962, US

(21) Appl. No.: 12/237,685

(22) Filed: Sep. 25, 2008

(51) Int. Cl. B32B 33/00; B05D 3/02; C08J 7/04

(52) U.S. Cl. 428/92; 427/385.5; 427/513

(57) ABSTRACT

The present invention the manufacture of a membrane for gas and liquid separations in which a polymer layer is applied directly to a tricot fabric instead of the conventional cloth or glass or metal substrate.

### BACKGROUND OF THE INVENTION

Considerable effort has been made to develop asymmetric and composite membranes for ultra-filtration, nano-filtration, pervaporation, reverse osmosis and gas separations. A solvent cast phase inversion process is generally used to make flat sheet membranes. In this process a suitable polymer, solvents and non-solvents (swelling agents) are chosen and mixed in appropriate proportions to provide the desired morphology for the membrane. Asymmetric membranes are formed by spreading a polymer solution (often referred to as a “casting dope”) into a thin film on top of a smooth substrate, using a doctor knife followed by precipitation in an aqueous bath and dried at elevated temperature. Membranes cast on smooth substrates such as glass, metal, metal plate or metal laminated with plastic such as polyethylene (Mylar®) or substrate coated with agent and subsequently release from it are called “free-standing” membrane. Handling problems as well as brittleness, wrinkling due to uneven shrinkage when dried are the major obstacles encountered with the “free-standing” membrane at large production scale. Such selective membranes can be very expensive to develop and produce, and accordingly they command a high price. Membranes cast on non-releasing substrate are referred to as “cast-on-cloth” membranes and the performances of the “cast-on-cloth” membranes greatly depend on the quality of the fabric that has to provide adequate mechanical strength and structural integrity to the overall membrane. Hence, the selection of the substrate is especially important for the class of membrane needs to withstand the pressure drop across the membrane which is encountered in and necessary for its operation, and otherwise endure a reasonable lifetime as an integral material in the intended operating environment.

### SUMMARY OF THE INVENTION

Those skilled in the art are well aware of limited choices of substrates that are able to provide the kind of properties that meets the membrane requirements. This is because the asymmetric or composite membrane is only best performed by a fabric substrate which (1) will provide adequate mechanical strength and structural integrity to the membrane; (2) present a smooth, uniform, planar (flat) surface without protruding fibers, on which the asymmetric membrane can be formed with minimum of pinholes and other defects; (3) is inert to chemical reactions and, (4) is porous and highly permeable, so as not to reduce the flux of the overall membrane. Typically, the suitable substrate fabrics have a thickness on the order of about 100 to about 125 microns. Preferably, woven cloths made from Nylon or Dacron® polyester are used. Other fabrics that can be used include: AWA® reinforced paper and the Hollytex® non-woven polyester. It was an object of this invention to provide a substrate for a selective asymmetric or composite membrane, which would combine the features of (1) can be made inexpensively by conventional phase inversion casting techniques, (2) exhibit excellent permeance and selectivity, (3) sustain the lifetime of the membrane under operating conditions and, (4) increase the packing density of the spiral wound or plate and frame module configuration.

### DETAILED DESCRIPTION OF THE INVENTION

The present invention is a process for preparing asymmetric separation membrane comprising a tricot supporting substrate which is coated with a “bisphenol-A” based epoxy which is cross-linked at a temperature of >200° C., a polymer dope which provides high permeance and selectivity over a wide range of temperature and pressure and, a finishing by coating the surface of the asymmetric membrane with a thermally curable or UV curable polysiloxane or other suitable coating. The asymmetric or composite separation membrane includes cellulosic membranes such as cellulose acetate-butyrate, cellulose propionate, ethyl cellulose, methyl cellulose, cellulose nitrate and membranes formed from other polymers dope such as polysulfone, polyethersulfone, polyamide, polyimide, polyetherimide, polyamide/imides; polyether ketones; poly(ether ether ketone)s, poly(arylene oxides); poly(esteramide-diisocyanate); polyurethanes; poly(benzobenzimidazole); polyhydrazides; polyoxadiazoles; polytriazoles; poly(benzimidazole); polycarbodiimides; polyphosphazines; microporous polymers, polycarbonate, polystyrene, polypropylene, perfluoropolymer, polyacrylic acid, polyarylates, polyethylene terephthalate, polysiloxane, polyacrylonitrile, polymethyacrylonitrile, polyvinylalcohol, polysulfide, polybenzoxazole, polyvinylidene fluoride and mixtures thereof.

More specifically, a membrane forming polymer film is directly cast upon the smooth side of the tricot fabric layer where the membrane forming polymer film is permanently and integrally bonded. Typically, the tricot substrate we use to make asymmetric and composite membranes in this invention will have a cross-linked epoxy coating ranging from 10 to 50% by weight of the epoxy resin. Between 20 to 30% by weight epoxy coating is preferred. The air permeability of the tricot is ranging from 1 to 20 cm³/(sec.cm²) and in this embodiment air permeability of tricot between 2 to 5 cm³/(sec.cm²) is preferred to use. The thickness of the tricot substrate should be between 100 to 500 microns and preferably between 250 to 400 microns. The density of the tricot substrate should be between 50 to 200 gm per sq. meter and preferably between 100 to 150 gm per sq. meter. Since tricot substrate is a close-knit design with fibers running lengthwise while employing an interlooped yarn pattern where one side will feature fine ribs running in a lengthwise pattern, while the other side may feature ribs that run in a crosswise direction, it should have 5 to 30 wales per cm on the rib side, between 10 to 15 wales per cm is preferred. In addition, on the smooth side of the tricot it should have 5 to 40 courses per cm, between 15 to 25 courses per cm is preferred in this invention. The total thickness of the “cast-on-tricot” asymmetric or composite membrane should be 400 to 800 microns, preferably between 500 to 650 microns. In accordance with the preferred embodiment of this invention, the “cast-on-tricot” membrane is fabricated by casting the polymer dope to form a thin layer of solution on the tricot substrate, precipitating the membrane in low or ambient temperature water ranging from 0 to 25° C., typically at about 0° C. is preferred, followed by annealing in high temperature water ranging from 25 to 90° C., typically at about 86° C. is preferred. The dry membrane can be achieved by evaporating water at or above ambient temperature ranging from 25 to 80° C., typically at about 65 to 70° C. The dry asymmetric “cast-on-tricot” membrane can be coated with an epoxy silicone solution containing epoxy silicone solution ranging from 2 to 15 wt-%, typically 8 to 10% is preferred. The silicone solvent contains a ratio of hexane to heptane solvent ranging from 1:1 to 1:5 ratio, typically 1:3 is preferred. The epoxy silicone coating then exposes to a UV source for a period of about between 1 to 10 minutes, typically 2 to 4 minutes is preferred, at ambient temperature to cure the coating while the silicone solvent evaporated to produce the epoxy silicone. The resulting “cast-on-tricot” asymmetric and composite membranes are suitable for the desalination of water by reverse osmosis, non-aqueous liquid separation, ultrafiltration, nanofiltration, pervaporation, and for all known gas separation end uses. Other advantages of using tricot as the backing substrate include reducing the pressure drop from feed to permeate side; increasing the packing density of the spiral-wound module, minimizing a membrane curling problem encountered in the use of cloth fabrics and reducing the material cost for making the membrane.

Unlike tricot used in the spiral-wound membrane module arrangement as the permeate spacer taught by Dutton U.S. Pat. No. 0,034,294 A1, the tricot is used as the supporting fabric of the asymmetric membrane during the phase inversion process in this invention. More importantly, while the smooth side of the tricot is used to support the asymmetric membrane the ribs side of the tricot can be used as the permeate spacer in the spiral wound or the plate & frame module configuration.

The following examples are provided to illustrate one or more preferred embodiments of the invention, but are not limited embodiments thereof. Numerous variations can be made to the following examples that lie within the scope of the invention.

### EXAMPLE 1

### Cellulose Diacetate (CA) & Cellulose Triacetate (CTA) Asymmetric Membrane

A cellulose acetate/cellulose tracetate asymmetric membrane was prepared from a casting dope comprising, by approximate weight percentages, 8% cellulose triacetate, 8% cellulose diacetate, 32% 1,3 dioxolane, 2% NMP, 24% acetone, 12% methanol, 2% maleic acid and 3% n-decane. A film was cast on a tricot web, then gelled by immersion in a 0° C. water bath for about 10 minutes, and then annealed in a hot water bath at 86° C. for 5 minutes. The resulting wet membrane was dried at a temperature between about 70° C. to remove water. The dry asymmetric cellulosic membrane was coated with an epoxy silicone solution containing an 2 wt-% epoxy silicone solution. The silicone solvent contained a 1:3 ratio of hexane to heptane. The epoxy silicone coating was exposed to a UV source for a period of about 2 to 4 minutes at ambient temperature to cure the coating while the silicone solvent evaporated to produce the epoxy silicone coated membrane of the present invention.

The epoxy silicone coated membranes were evaluated for gas transport properties using a feed gas containing 10 vol-% CO₂ and 90 vol-% CH₄ at a feed pressure of 6.89 MPa (1000 psig) and 50° C. Table 1 shows a comparison of the CO₂ permeability and the selectivity (α) of the dense film (intrinsic properties) and the asymmetric membrane performances.

TABLE 1
Gas Transport Properties

| | | CO₂/CH₄ |
|---|---|---|
| Membrane | CO₂ | Selectivity |
| Dense film | 7.2 Barrers* | 21.9 |
| Asymmetric membrane | 199 (GPU**) | 14.2 |

*Barrer = 10⁻¹⁰ cm³(STP)cm/sec · cm³ · cmHg
**Gas Permeation Unit (GPU) = 10⁻⁶ cm³(STP)/cm²sec · cmHg

### EXAMPLE 2

### Cellulose Diacetate (CA) & Cellulose Triacetate (CTA) Asymmetric Membrane

A cellulose acetate/cellulose tracetate asymmetric membrane was prepared from a casting dope comprising, by approximate weight percentages, 8% cellulose triacetate, 8% cellulose diacetate, 32% 1,3 dioxolane, 2% NMP, 24% acetone, 12% methanol, 2% maleic acid and 3% n-decane. A film was cast on a tricot web, then gelled by immersion in a 0° C. water bath for about 10 minutes, and then annealed in a hot water bath at 86° C. for 5 minutes. The resulting wet membrane was dried at a temperature between about 70° C. to remove water. Table 2 shows a comparison of the CO₂ permeability and the selectivity (α) of the dense film (intrinsic properties) and the asymmetric membrane performances.

TABLE 2
Gas Transport Properties

| | | CO₂/CH₄ |
|---|---|---|
| Membrane | CO₂ | Selectivity |
| Dense film | 7.2 Barrers* | 21.9* |
| Asymmetric membrane | 53 GPU | 14.9 |

*Dense film was tested at 690 kPa (100 psig), 50° C. and pure gas

### EXAMPLE 3

### P84 Polyimide/Polyethersulfone Blended Asymmetric Membrane

A P84 polyimide/polyethersulfone blended asymmetric membrane was prepared in from a casting dope comprising, by approximate weight percentages, 6.5% polyethersulfone, 12.2% P84 polyimide, 50.5% 1, 3 dioxolane, 24.3% NMP, 3.7% acetone, and 2.8% methanol. A film was cast on a tricot web, then gelled by immersion in a 0° C. water bath for about 10 minutes, and then annealed in a hot water bath at 86° C. for 5 minutes. The resulting wet membrane was dried at a temperature between 65° and 70° C. to remove water. The dry asymmetric membrane was coated with an epoxy silicone solution containing 8 wt-% epoxy silicone solution. The silicone solvent had a 1:3 ratio of hexane to heptane. The epoxy silicone coating was exposed to a UV source for a period of 2 to 4 minutes at ambient temperature to cure the coating while the silicone solvent evaporated to produce the epoxy silicone coated membrane of the present invention.

The epoxy silicone coated membranes were evaluated for gas transport properties using a feed gas containing 10 vol-% CO₂, 90 vol-% CH₄ at a feed pressure of 6.89 MPa (1000 psig) and 50° C. Table 3 shows a comparison of the CO₂ permeability and the selectivity (α) of the dense film (intrinsic properties) and the asymmetric membrane performances. Table 3 shows a comparison of the CO₂ permeability and the selectivity (α) of the dense film (intrinsic properties) and the asymmetric membrane performances.

TABLE 3
Gas Transport Properties

| | | CO₂/CH₄ |
|---|---|---|
| Membrane | CO₂ | Selectivity |
| Dense film | 2.7 Barrers* | 33.7* |
| Asymmetric membrane | 51 GPU | 24.7 |

*Dense film was tested at 690 kPa (100 psig), 50° C. and pure gas

1. A process for preparation of a membrane comprising applying a polymer solution to one side of a sheet of a fabric wherein said fabric comprises a series of interconnected loops in one direction and lines of loops in a perpendicular direction and after application of said polymer solution removing solvent ingredients from said polymer solution.

2. The process of claim 1 wherein said polymer is selected from the group consisting of polysulfones; polyethersulfone; polyetherimides; cellulosic polymers; polyamides; polyimides; polyamide/imides; polyether ketones; poly(ether ether ketone)s, poly(arylene oxides); poly(esteramide-diisocyanate); polyurethanes; poly(benzobenzimidazole); polyhydrazides; polyoxadiazoles; polytriazoles; poly(benzimidazole); polycarbodiimides; polyphosphazines; microporous polymers; polysiloxane; polyacrylonitrile; polymethyacrylonitrile; polyvinylalcohol; polysulfide; polybenzoxazole; polyvinylidene fluoride and mixtures thereof.

3. The process of claim 1 wherein said sheet of fabric has been coated with a layer of a water based epoxy and crosslinked with heat.

4. The process of claim 3 wherein said epoxy is bisphenol-A.

5. The process of claim 2 wherein said cellulosic polymer comprises cellulose diacetate or cellulose triacetate.

6. The process of claim 2 wherein said polymer comprises a polyimide.

7. The process of claim 6 wherein said polymer further comprises a polysulfone.

8. The process of claim 1 wherein said sheet of fabric is a tricot fabric.

9. The process of claim 1 further comprising applying a UV radiation crosslinkable coating on said polymer and then crosslinking said UV radiation crosslinkable coating.

10. An asymmetric membrane comprising a polymer layer on a sheet of fabric comprising a series of interconnected loops in one direction and lines of loops in a perpendicular direction.

11. The asymmetric membrane of claim 10 wherein said polymer is selected from the group consisting of polysulfones; polyetherimides; cellulosic polymers; polyamides; polyimides; polyamide/imides; polyether ketones; poly(ether ether ketone)s, poly(arylene oxides); poly(esteramide-diisocyanate); polyurethanes; poly(benzobenzimidazole); polyhydrazides; polyoxadiazoles; polytriazoles; poly(benzimidazole); polycarbodiimides; polyphosphazines; microporous polymers; and mixtures thereof.

12. The asymmetric membrane of claim 10 wherein said sheet of fabric comprises tricot fabric.

13. The asymmetric membrane of claim 10 in a form of a spiral wound module.

14. The asymmetric membrane of claim 10 further comprising a UV radiation crosslinked coating.

15. The process of claim 11 wherein said cellulosic polymer comprises cellulose diacetate or cellulose triacetate.

16. The process of claim 11 wherein said polymer comprises a polyimide.

17. The process of claim 16 wherein said polymer further comprises a polysulfone.
